(19) United States
(12) Patent Application Publication
(10) Pub. No.: US 2013/0079482 A1
(43) Pub. Date: Mar. 28, 2013

(54) AEROSOL PHOTOPOLYMERIZATION

(71) Applicants: Wolfgang Gerlinger, Limburgerhof (DE); Michael Wörner, Bretten (DE); Ertan Akgün, Karlsruhe (DE)

(72) Inventors: Wolfgang Gerlinger, Limburgerhof (DE); Michael Wörner, Bretten (DE); Ertan Akgün, Karlsruhe (DE)

(73) Assignee: BASF SE, Ludwigshafen (DE)

(21) Appl. No.: 13/530,676

(22) Filed: Jun. 22, 2012

Related U.S. Application Data
(60) Provisional application No. 61/538,166, filed on Sep. 23, 2011.

(51) Int. Cl. B29B 9/00; C08F 220/18; C08F 20/14; C08F 20/28; C08F 20/18

(52) U.S. Cl. 526/320; 526/328; 526/329.7; 526/328.5; 264/12

(57) ABSTRACT

The present invention relates to a process for producing nanoparticles comprising at least one polymer and/or copolymer by providing an aerosol comprising droplets of at least one monomer and at least one photoinitiator in a gas stream, irradiating this aerosol stream with light such that the monomers present polymerize, and removing the nanoparticles formed from the gas stream, to nanoparticles producible by this process and to the use of these inventive nanoparticles in optical, electronic, chemical or biotechnological systems, or for active ingredient administration.

### CROSS-REFERENCE TO RELATED APPLICATIONS

This application claims benefit (under 35 USC 119(e)) of U.S. Provisional Application 61/538,166, filed Sep. 23, 2011, which is incorporated by reference.

The present invention relates to a process for producing nanoparticles comprising at least one polymer and/or copolymer by providing an aerosol comprising droplets of at least one monomer and at least one photoinitiator in a gas stream, irradiating this aerosol stream with light such that the monomers present polymerize, and removing the nanoparticles formed from the gas stream, to nanoparticles producible by this process and to the use of these inventive nanoparticles in optical, electronic, chemical or biotechnological systems, or for active ingredient administration.

Processes for producing nanoparticles from polymeric organic materials are already known from the prior art.

US 2007/0142589 A1 discloses a process for producing polymeric microparticles. For this purpose, a liquid comprising corresponding monomeric compounds is nebulized to obtain a cloud of polymerization-initiated monomer droplets in a gas-filled reaction zone. Under the action of gravity, these liquid droplets fall through a reaction zone and begin to polymerize. The particles are then collected and removed from the reaction zone. According to the example, neutralized acrylic acid in aqueous solution is sprayed against a gas plate at 50 to 80° C. in a reaction chamber by means of a spray bottle. After about one minute, corresponding microspheres can be detected on this gas plate.

Morita et al. disclose processes for producing nanoparticles from organic materials; see, for example, Journal of Photopolymer Science and Technology, Volume 12, Number 1 (1999), 95-100, Journal of Photopolymer Science and Technology, Volume 12, Number 1 (1999) 101-106, Journal of Photopolymer Science and Technology, Volume 13, Number 1 (2000), 159-162, Journal of Photochemistry and Photobiology, A: Chemistry, 150 (2002), 7-11, or Journal of Photochemistry and Photobiology, A: Chemistry, 103 (1997), 27-31. The processes specified in these documents comprise the production of nanoparticles from organic monomers. These monomers, for example acrolein, carbon disulfide and/or trimethylsilylacetylene, are vaporized and the gaseous monomer mixture is then polymerized. The free-radical polymerization is initiated by irradiation with high-energy laser beams. The polymerization of liquid monomers is not mentioned in these documents.

US 2008/0187663 discloses a process for depositing polymeric materials on particular surfaces. For this purpose, a mixture comprising polymerizable components is vaporized and deposited on the corresponding surfaces under reduced pressure.

The processes known from the prior art for production of polymer particles have the disadvantage that the particle size cannot reliably be predetermined. Furthermore, it is not possible by the processes according to the prior art to obtain particles which feature high homogeneity, for example a narrow particle size distribution or homogeneous particle shape or homogeneous particle composition. The processes from the prior art are also unsuitable for producing nanoparticles with diameters less than 3 μm. The processes from the prior art are additionally not necessarily suited to a continuous mode of operation.

It is therefore an object of the present invention, with respect to the prior art, to provide a process for producing nanoparticles comprising at least one polymer and/or copolymer, which makes these particles obtainable with predeterminable diameters. Furthermore, the process shall be operable continuously, as a result of which it is easier to implement industrially. The residence time is preferably to be adjustable by changing the length of the reactor, such that substantially complete conversion of the monomers is possible.

These objects are achieved by the process according to the invention for producing nanoparticles comprising at least one polymer and/or copolymer by providing an aerosol comprising droplets of at least one monomer and at least one photoinitiator in a gas stream, irradiating this aerosol stream with light such that the monomers present polymerize, and removing the nanoparticles formed from the gas stream.

### A BRIEF DESCRIPTION OF THE FIGURES

FIG. 1 shows a scanning electron microscope image of crosslinked PMMA polymer particles which have been produced by the process according to the invention.

FIG. 2 shows images of nanostructured polymer particles. Depicted on the left are nanodishes (scanning electron microscope image), and on the right are depicted hybrid nanoparticles consisting of ZnO nanoparticles and a polymer (transmission electron microscope image).

FIG. 3 shows a schematic diagram of a dish-shaped particle. dₐ is the outer diameter and dᵢ the inner diameter. dᵢ is calculated from the diameter of the largest sphere which fits in the indentation, without this sphere projecting beyond the indentation.

FIG. 4 shows a particle size distribution characteristic of the invention. The x axis shows the diameter of the particles in nm; the y axis describes the number of particles per cm³.

FIG. 5 shows a scanning electron microscope image of nanodishes having benzyl methacrylate as the monomer according to example 23.

FIG. 6 shows a scanning electron microscope image of hybrid nanodishes having methyl methacrylate as the monomer and ZnO as nanoparticle according to example 24.

FIG. 7 shows a transmission electron microscope image of hybrid nanodishes having methyl methacrylate as the monomer and ZnO as nanoparticle according to example 24.

FIG. 8 shows a scanning electron microscope image of copolymer-particles made of butylacrylate (BA) and methyl methacrylate (MMA) as the monomers according to example 29.

### A DETAILED DESCRIPTION OF THE INVENTION

The process according to the invention is explained in detail hereinafter.

The process according to the invention is preferably performed continuously.

The process according to the invention makes it possible to obtain nanoparticles comprising at least one polymer and/or copolymer. According to the invention, the term “nanoparticles” comprises particles having a diameter, i.e. the longest distance present in the particle, of 40 to 3000 nm, preferably 50 to 1000 nm, more preferably between 50 and 400 nm or 50 and 200 nm. According to the invention, the particles produced comprise at least one polymer and/or copolymer. The term “copolymer” is understood in accordance with the invention to mean a polymer formed from at least two different monomers. In a preferred embodiment, the nanoparticles produced in accordance with the invention consist of at least one polymer and/or copolymer. In further preferred embodiments, the nanoparticles produced in accordance with the invention additionally comprise at least one nanoparticulate additive.

The nebulizer or sprayer used in accordance with the invention can in principle also be used to obtain larger particles than the particles obtained in accordance with the invention. The flow direction of the gas stream within the reactor is not crucial for the invention.

The nanoparticles produced in accordance with the invention may generally have any shape; preferably, the nanoparticles are ball-shaped or dish-shaped or are hollow balls or gel-like balls.

The present invention therefore preferably relates to the process according to the invention wherein the nanoparticles are ball-shaped, dish-shaped or hollow balls or gel-like balls.

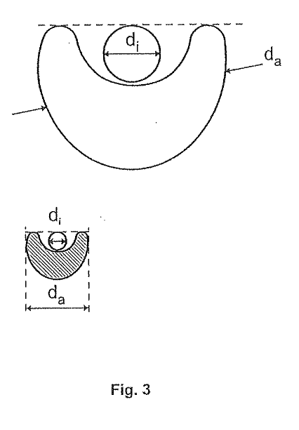

“Dish-shaped” in the context of the present invention means that a particle is formed having the abovementioned diameter as the external diameter dₐ, and a concave indentation with a smaller internal diameter. This internal diameter dᵢ is determined by the diameter of the largest sphere which fits in the indentation without this sphere projecting beyond the indentation; see also FIG. 3.

In the process according to the invention, an aerosol comprising droplets of at least one monomer and at least one photoinitiator is provided in a gas stream. The inventive use of an aerosol has the advantage over the emulsion-based processes of the prior art that a surfactant-free system, i.e. a pure mixture of monomer plus photoinitiator, can be used.

According to the invention, the gas stream may be an inert gas stream, for example selected from the group consisting of nitrogen (N₂), carbon dioxide (CO₂), argon (Ar), helium (He) and mixture thereof, or air. If the inventive polymerization is initiated and performed by free-radical means, preference is given to using an inert gas stream. If the inventive polymerization is initiated and performed by cationic means, preference is given to using an air or inert gas stream.

The present invention therefore preferably relates to the process according to the invention wherein the gas stream is an inert gas stream, for example selected from the group consisting of nitrogen (N₂), carbon dioxide (CO₂), argon (Ar), helium (He) and mixtures thereof, and the polymer is formed by free-radical polymerization.

The present invention further preferably relates to the process according to the invention wherein the gas stream is an air or inert gas stream, for example selected from the group consisting of nitrogen (N₂), carbon dioxide (CO₂), argon (Ar), helium (He) and mixtures thereof, and the polymer is formed by cationic polymerization.

In general, it is possible in accordance with the invention to use all monomers which feature a high reactivity, i.e. a high polymerization rate under the inventive reaction conditions.

Since, in a preferred embodiment, the polymerization reaction should proceed up to a residual monomer content in the particle of not more than 30%, preferably not more than 20% and more preferably not more than 10% within a period of less than 2 minutes, preferably less than 1.5 minutes and more preferably less than 1 minute, particular preference is given to using monomers having a correspondingly high polymerization rate under the inventive reaction conditions in the process according to the invention.

A measure which can be used for the reaction rate of a polymerization reaction generally is the chain growth rate coefficient Kₚ. The determination of Kₚ is known per se to those skilled in the art and is described, for example, in Beuermann, S.; Buback, M. Prog. Polym. Sci. 2002, 27, 191.

Preferably in accordance with the invention, the chain growth rate coefficient Kₚ of the polymerization reaction is greater than 500 mol/l/s, more preferably greater than 1000 mol/l/s, even more preferably greater than 2000 mol/l/s, especially 5000 mol/l/s, further preferably greater than 10 000 mol/l/s.

The present invention therefore relates preferably to the process according to the invention wherein the chain growth rate coefficient Kₚ of the polymerization reaction is greater than 500 mol/l/s, preferably greater than 1000 mol/l/s, more preferably greater than 2000 mol/l/s, even more preferably 5000 mol/l/s, especially greater than 10 000 mol/l/s.

In addition, the reaction rate can also be described by what is called the Damköhler number Da, which is formed by the ratio of residence time in the reactor and reaction time:

Da=Kₚ*c₀*τ

The reaction time is calculated from the product of chain growth rate coefficient Kₚ and mean starting concentration of the mixture of monomer and crosslinker c₀.

The residence time in the reactor τ is calculated from the internal volume of the reactor divided by the aerosol volume flow rate.

The starting concentration is calculated from the weighted mean of monomer and crosslinker concentration in the droplets.

In the process according to the invention, the Damköhler number Da of the polymerization reaction is preferably greater than 200 000, more preferably greater than 500 000 and most preferably greater than 1 000 000.

The present invention therefore preferably relates to the process according to the invention, wherein the Damköhler number Da of the polymerization reaction is greater than 200 000, preferably greater than 500 000, more preferably greater than 1 000 000.

In the process according to the invention, it is possible with preference to use at least one monomer selected from the group consisting of olefinically unsaturated, preferably α,β-unsaturated, monomers, epoxides, cyclic ethers, acetals and mixtures thereof.

The present invention therefore preferably relates to the process according to the invention wherein the at least one monomer is selected from the group consisting of olefinically unsaturated, preferably α,β-unsaturated, monomers, epoxides, cyclic ethers, acetals and mixtures thereof.

In general, α,β-unsaturated monomers are known to those skilled in the art. α,β-Unsaturated monomers preferred in accordance with the invention are selected from the group consisting of acrylic acid, methacrylic acid, acrylic esters, methacrylic esters, styrene, styrene derivatives, vinylic monomers, acrylamides, methacrylamides and mixtures thereof.

Acrylic esters and methacrylic esters used with preference are compounds of the general formula (I)

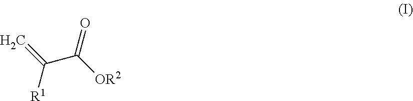

where

R¹ is hydrogen (acrylic acid) or methyl (methacrylic acid) and

R² is a linear or branched, optionally substituted alkyl group having 1 to 12 carbon atoms, linear or branched, optionally substituted alkenyl group having 2 to 12 carbon atoms, optionally substituted aryl group having 5 to 18 carbon atoms, or optionally substituted heteroaryl group having 4 to 18 carbon atoms.

The group mentioned may optionally have further functional groups, for example alcohol, keto or ether groups, or heteroatoms, for example N, O, P or S.

The aryl and heteroaryl groups mentioned may optionally be attached to the oxygen atom of the acid functionality via a saturated or unsaturated, optionally substituted carbon chain having 1 to 12 carbon atoms, preferably one or two carbon atoms.

Examples of any heteroatoms present are selected from the group consisting of N, O, P, S and mixtures thereof.

Styrene is known per se to those skilled in the art and corresponds to the following formula (II)

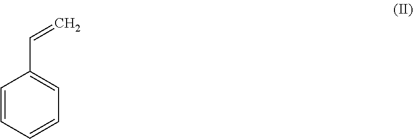

Derivatives of styrene are, for example, corresponding compounds which derive from styrene and bear further substituents, for example methyl, on the aromatic ring and/or on the double bond. A preferred styrene derivative is α-methylstyrene.

Epoxides are known per se to those skilled in the art and are selected, for example, from the group consisting of ethylene oxide, propylene oxide, butylene oxide, styrene oxide and mixtures thereof.

Preferably in accordance with the invention, the at least one monomer is selected from the group consisting of acrylic acid, butyl acrylate, benzyl acrylate, hydroxyethyl methacrylate (HEMA), 2-hydroxypropyl methacrylate (HPMA), alkyl 2-cyanoacrylates such as ethyl cyanoacrylate (ECA), methacrylic acid, methyl methacrylate (MMA), butyl methacrylate, benzyl methacrylate, styrene, a-methylstyrene, 4-vinylpyridine, vinyl chloride, vinyl alcohol, vinyl ether, N-isopropylacrylamide (NIPAM), acrylamide, methacrylamide and mixtures thereof.

For a cationic, photoinitiated polymerization, preference is given to using vinyl ethers and/or isopropenylbenzene (α-methylstyrene). For a cationic photoinitiated (ring-opening) polymerization, preference is given to using epoxides, cyclic ethers and/or acetals. Differential

For an anionic, photoinitiated polymerization, preference is given to using alkyl 2-cyanoacrylate, acrylonitrile, styrene (derivatives), acrylic esters and/or epoxides.

An aerosol comprising droplets of at least one monomer and at least one photoinitiator in a gas stream can generally be provided by any process known to those skilled in the art, or using the apparatuses commonly known to the person skilled in the art. Particular preference is given to providing the aerosol in a nebulizer or atomizer, for example by spraying the monomer or the monomer solution (comprising monomers, photoinitiator, optionally additives such as nanoparticles, optionally crosslinker, optionally solvent, optionally cosolvent) with the aid of a two-substance nozzle or with an electrospray or with an ultrasound nebulizer.

One advantage of the photopolymerization performed in accordance with the invention over thermally induced polymerization is that the temperature is increased in the latter case. This vaporizes the monomers or a portion thereof, such that the particle diameter cannot be adjusted in a simple manner via the adjustment of the droplet diameter. It may then be the case that the droplets do not polymerize at all. At the same time, the substance parameters vary with increasing temperature (for example surface tension and viscosity), which likewise adversely affects the stability of the droplets. As a result of vaporization of monomer, more particularly, it is impossible by a thermally induced polymerization to produce a 1:1 copy (i.e. particle diameter=droplet diameter). Compared to a thermally initiated polymerization, the process according to the invention can be performed at lower temperatures, such that a lower proportion of the monomers vaporizes. As a result, the droplet size more accurately determines the particle size.

According to the invention, it is also possible through selection of the atomizer to establish particularly narrow particle size distributions, for example by classification of the droplets by means of a differential mobility analyzer (DMA).

At the point in the reactor where the polymerization reaction is effected, the gas stream generally has a flow rate of 0.1 to 100 cm/s, preferably 0.5 to 10 cm/s, more preferably 0.5 to 2 cm/s.

The aerosol provided in accordance with the invention comprises droplets of at least one monomer and at least one photoinitiator in a gas stream. The process according to the invention is preferably performed in such a way that a droplet concentration in the gas stream of preferably 10⁶ to 10¹⁰ droplets/cm³, preferably 10⁶ to 10⁸ droplets/cm³, even more preferably 1×10⁷ to 1×10⁸ droplets/cm³, for example 5×10⁷ droplets/cm³, is present. The droplet concentration can be determined, for example, with a Scanning Mobility Particle Sizer (SMPS) or a condensation particle counter.

Preferably in accordance with the invention, the gas stream is formed using N₂ (nitrogen). This nitrogen may originate from all sources known to those skilled in the art, for example from commercially available storage bottles, from the distillation of air, etc. The other inert gases mentioned may likewise originate from sources known to those skilled in the art. The air used is preferably ambient air or compressed air.

Preferably in accordance with the invention, the pressure in the gas stream is atmospheric pressure or slightly elevated atmospheric pressure. In the context of the present invention, “slight elevated atmospheric pressure” means a pressure which is, for example, 1 to 500 mbar above atmospheric pressure. The particular purpose of this preferably slightly elevated pressure is that the gas stream overcomes the resistance of any filter or any deposition liquid.

The process according to the invention is preferably performed at a temperature of 10 to 80° C., preferably 20 to 35° C., for example 30° C. The advantage of the photopolymerization performed in accordance with the invention is that it can be performed at low temperatures, and fewer chain transfers take place as a result.

The droplets present in the aerosol provided in accordance with the invention comprise, as well as the at least one monomer, at least one photoinitiator.

According to the invention, it is possible to use all photoinitiators which are known to those skilled in the art and which can bring about a free-radical or ionic, i.e. cationic or anionic, polymerization reaction of the at least one monomer used. Since the monomer mixture is irradiated with light for polymerization, preference is given in accordance with the invention to using photoinitiators which release a sufficiently large amount of (primary) free radicals as a result of irradiation with light. In the context of the present invention, “light” is understood to mean UV light or visible light, i.e. electromagnetic radiation with a wavelength of 150 to 800 nm, preferably 180 to 500 nm, more preferably 200 to 400 nm, especially 250 to 350 nm. Preference is given in accordance with the invention to using UV light.

Examples of photoinitiators preferred in accordance with the invention for a free-radical polymerization are selected from the group consisting of 2-methyl-1-[4-(methylthio)phenyl]-2-morpholinopropan-1-one (for example obtainable under Irgacure® 907 brand name), 2,2′-azobisisobutyronitrile (AIBN) and further nonsymmetric azo derivatives, benzoin, benzoin alkyl ethers, benzoin derivatives, acetophenones, benzil ketals, α-hydroxyalkylphenones, α-aminoalkylphenones O-acyl-α-oximinoketones, (bi)acylphosphine oxides, thioxanthone (derivatives) and mixtures thereof.

Examples of photoinitiators preferred in accordance with the invention for a cationic photopolymerization are selected from the group consisting of substituted diaryliodonium salts, substituted triarylphosphonium salts and mixtures thereof.

Examples of photoinitiators preferred in accordance with the invention for an anionic photopolymerization are selected from the group consisting of transition metal complexes, N-alkoxypyridinium salts, N-phenylacylpyridinium salts and mixtures thereof.

According to the invention, what is called a living anionic polymerization can also be performed in the pure polymer mixture, optionally comprising a secondary functionalization by termination reagent, for example by injecting a gaseous or vaporizable chemical compound into the aerosol space, preferably in the outlet zone.

According to the invention, the photoinitiators used may also be particular nanoparticles, for example ZnO and/or TiO₂ in nanoparticulate form. These are also used with preference as an additive in accordance with the invention. Therefore, in a preferred embodiment of the process according to the invention, at least one nanoparticle, for example ZnO and/or TiO₂ in nanoparticulate form, is used both as a photoinitiator and as an additive.

The amount of photoinitiator in the droplets present in the aerosol provided in accordance with the invention is, for example, 0.1 to 10% by weight, preferably 0.5 to 8% by weight and more preferably 0.8 to 6% by weight, based in each case on the amount of the at least one monomer present.

The present invention relates, in a preferred embodiment, to the process according to the invention wherein no solvent is present in the droplets, and ball-shaped nanoparticles are formed.

In a further preferred embodiment of the process according to the invention, the droplets additionally comprise at least one solvent.

In the embodiment preferred in accordance with the invention, the at least one solvent is present in the droplets, preference is given in accordance with the invention to forming dish-shaped nanoparticles. By adjusting the monomer solution comprising at least one solvent, it is additionally also possible to produce hollow balls or gel-like balls.

The present invention therefore relates, in a preferred embodiment, to the process according to the invention wherein at least one solvent is present in the droplets and dish-shaped or hollow ball-shaped nanoparticles are formed.

Solvents preferred in accordance with the invention are those in which the at least one monomer is soluble, but the polymer formed is insoluble.

Examples of solvents preferred in accordance with the invention are polar organic solvents such as alcohols, ketones, esters of carboxylic acids or mixtures thereof, or polar aprotic organic solvents such as acetonitrile. Further possible solvents are hexane, (methyl)cyclohexane, cyclic ethers such as THF or dioxane, or ionic liquids. Mixtures of the solvents mentioned are also possible.

Suitable alcohols are, for example, selected from the group consisting of methanol, ethanol, propanols such as n-propanol and isopropanol, butanols such as n-butanol, isobutanol and tert-butanol, pentanols and mixtures thereof.

Ketones suitable in accordance with the invention are, for example, selected from the group consisting of acetone, methyl ethyl ketone and mixtures thereof.

Esters of carboxylic acids suitable in accordance with the invention are, for example, selected from the group consisting of ethyl acetate, methyl acetate and mixtures thereof.

In a further possible embodiment of the process according to the invention, it is also possible for the at least one monomer to function as a solvent. For this purpose, the operating parameters are adjusted such that not all monomer is converted. Not everything is converted, for example up to a residual monomer content in the particle of not more than 30%, preferably not more than 20% and more preferably not more than 10%, and the remainder vaporizes, such that the residual monomer content in the finished particles can nevertheless be very low.

Particular preference is given in accordance with the invention to using ethanol or 1-propanol (n-propanol) as the solvent.

According to the invention, the at least one solvent is used, for example, in an amount of 10 to 80% by volume, preferably 30 to 70% by volume and more preferably 40 to 60% by volume, based in each case on the amount of the at least one monomer.

In a further preferred embodiment, the droplets additionally comprise at least one crosslinker.

The present invention therefore preferably relates to the process according to the invention wherein the droplets additionally comprise at least one crosslinker.

Crosslinkers usable in accordance with the invention are known per se to those skilled in the art. The crosslinkers bring about crosslinking in the polymerization reaction of the monomers provided, and hence an increase in the molecular weight of the resulting polymers. Examples of suitable crosslinkers are selected from the group consisting of 1,6-hexanediol diacrylate (HDDA), diethylene glycol dimethacrylate (EGDMA), allyl methacrylate (AMA), trifunctional acrylates such as trimethylolpropane trimethacrylate (PMPTMA) and mixtures thereof.

According to the invention, the at least one crosslinker is used, for example, in an amount of 2 to 80% by volume, preferably 2 to 20% by volume and more preferably 3 to 15% by volume, based in each case on the amount of the at least one monomer.

According to the invention, at least one cosolvent can additionally be added to the droplets. This cosolvent serves, for example, through a change in the physical, chemical or mechanical properties during the polymerization, for example solution properties of monomers and polymers, surface tension, vapor pressure, stability of the droplets, or viscosity, to positively influence the particle structure. The cosolvent is, for example, selected from the group consisting of glycerol, glycol, polyethylene glycol, EO/PO copolymers, silicone oils and mixtures thereof.

The present invention therefore preferably relates to the process according to the invention wherein the droplets additionally comprise at least one cosolvent selected from the group consisting of glycerol, glycol, polyethylene glycol, EO/PO copolymers, silicone oils and mixtures thereof.

In a further preferred embodiment, the droplets additionally comprise at least one further additive.

The present invention therefore preferably relates to the process according to the invention wherein the droplets additionally comprise at least one further additive.

In principle, it is possible to use all additives which appear suitable to those skilled in the art. Preferred examples of corresponding additives are inorganic materials and/or active ingredients, for example pharmaceutical, biological, insecticidal, pesticidal active ingredients. For any additives present, it is essential that they do not absorb all of the radiation provided on irradiation of the gas stream with light, preferably UV light. The additives mentioned are preferably in nanoparticulate or dissolved form.

In a preferred embodiment, any additives additionally present are metals or metal and/or semimetal oxides, for example selected from the group consisting of ZnO, TiO₂, Fe oxides such as FeO, Fe₂O₃, Fe₃O₄, SiO₂ and mixtures thereof.

In a preferred embodiment, the at least one additive, especially the metal and/or semimetal oxide, is in nanoparticulate form, i.e. with a diameter of 1 to 400 nm, preferably 5 to 100 nm, especially 10 to 50 nm. The nanoparticles may be of any shape, for example ball-shaped, cube-shaped, rod-shaped.

According to the invention, the at least one additive is used, for example, in an amount of 0.1 to 40% by weight, preferably 0.5 to 25% by weight, more preferably 0.6 to 22% by weight, based in each case on the amount of the at least one monomer.

If, in accordance with the invention, the additives mentioned are additionally added, what are obtained in accordance with the invention are hybrid nanoparticles comprising at least one polymer and/or copolymer and at least one additive. These are preferably ball-shaped. The hybrid nanoparticles according to the invention can also preferably be dish-shaped.

Preferably in accordance with the invention, the droplet diameter is adjusted through the selection of the operating conditions of the atomizer, for example through the supply pressure to the atomizer, ratio of flow rate of gas and liquid, etc. In the case of the electrospray process it is possible, for example, to vary the voltage, and in the case of an ultrasound nebulizer the energy input. In addition, it is possible in accordance with the invention to select a particular size fraction by means of a differential mobility analyzer (DMA).

The amount of at least one monomer and at least one photoinitiator which are introduced into the gas stream is, in accordance with the invention, such that a corresponding number of particles per unit volume is obtained. According to the invention, the amount of at least one monomer can be used to calculate the size of the liquid droplets formed in the aerosol, and hence the size of the nanoparticles obtained after the polymerization. Preferred diameters of the droplets present in the aerosol are, for example, 40 to 3000 nm, preferably 50 to 1000 nm, more preferably 50 to 400 nm or 50 or 200 nm.

It is thus possible in accordance with the invention to control the size of the nanoparticles to be produced. The size of nanoparticles produced in accordance with the invention is therefore, for example, 40 to 3000 nm, preferably 50 to 1000 nm, more preferably 50 to 400 nm or 50 to 200 nm.

In the process according to the invention, the gas stream which an aerosol comprising droplets of at least one monomer and at least one photoinitiator, optionally comprising at least one solvent, at least one additive, for example an inorganic material, and/or at least one crosslinker, is irradiated with light, preferably UV light, such that the monomers present polymerize. The inventive irradiation of the gas stream with light can generally be effected in any apparatus known to those skilled in the art. Preference is given in accordance with the invention to using UV light. This can be generated by all apparatuses known to those skilled in the art, for example LEDs, excimer radiators, for example comprising xenon chloride (XeCl, 308 nm), xenon fluoride (XeF, 351 nm), krypton fluoride (KrF, 249 nm), krypton chloride (KrCl, 222 nm), argon fluoride (ArF, 193 nm) or Xe₂ (172 nm) as the laser-active medium, for example at 10 mW/cm² on the radiator surface, or with a UV fluorescence tube, for example at 8 mW/cm² on the radiator surface. The use of an excimer radiator is advantageous since it can be dimmed by pulsed operation, for example to 10 to 100%. As a result, optimization of the polymerization operation is possible in a relatively simple manner.

In a preferred embodiment of the process according to the invention, the inner reactor wall is flushed with an inert gas, for example with N₂, Ar, He, CO₂ or mixtures thereof. This serves, for example to suppress wall losses as a result of polymer film formation.

In a further preferred embodiment of the process according to the invention, it is additionally possible to inject a reactive gas for secondary functionalization of the nanoparticles formed.

Thus, after departure from the irradiation chamber used with preference in accordance with the invention, the polymerization within the nanoparticles is essentially complete, and so corresponding nanoparticles which have a solid surface and thus do not change any further in the further process steps, for example removal of the nanoparticles formed, are obtained. In accordance with the invention, this gives the advantage that virtually completely ball-shaped or dish-shaped nanoparticles are formed. A further advantage is that the size of the droplets substantially predefines the size of the particles produced. In setting the droplet size by means of the atomizer, it is thus possible to directly set the resultant particle size.

The molecular weight of the at least one polymer and/or copolymer obtained in accordance with the invention is generally 1000 to 1 000 000 g/mol, preferably 10 000 to 100 000 g/mol.

In a last process step, the nanoparticles formed are removed. The removal can in principle be effected by all processes known to those skilled in the art. In a preferred embodiment, the nanoparticles formed are removed by deposition on a filter or by introduction into a liquid medium.

The present invention therefore preferably relates to the process according to the invention wherein the nanoparticles formed are removed by deposition on a surface of a filter or by introduction into a liquid medium.

Suitable filters are known per se to those skilled in the art, for example polyamide filters, polycarbonate filters, PTFE filters, for example with pore sizes of 50 nm, electrostatic filters.

Separation in a liquid can be effected, for example, with a wash bottle or a wet electrostatic filter.

Any liquid medium used may be selected from the group consisting of water, ethanol, organic solvents, for example the abovementioned nonpolar solvents of all kinds, for example alkanes, cycloalkanes and mixtures thereof. The introduction of the nanoparticles produced preferably forms a suspension of the particles in the liquid medium. According to the invention, this suspension can be processed further, for example by removal of the particles from the suspension. According to a further embodiment this suspension is the process product desired in accordance with the invention and can be introduced directly into the corresponding application.

The present invention also relates to nanoparticles producible by the process according to the invention. These are notable for a particularly homogeneous shape, either dish-shaped or ball-shaped, hollow balls or gel-like balls, and/or a particularly narrow particle size distribution.

Nanoparticles produced in accordance with the invention are, due to their size, structure, composition and homogeneity, particularly suitable for applications in optical, electronic, chemical or biotechnological systems, or for active ingredient administration.

The present invention therefore preferably relates to the use of the nanoparticles produced in accordance with the invention in optical, electronic, chemical or biotechnological systems, or for active ingredient administration.

The present invention therefore preferably relates to the inventive use wherein the nanoparticles are used as photosensitizers and/or photoinitiators.

### FIGURES

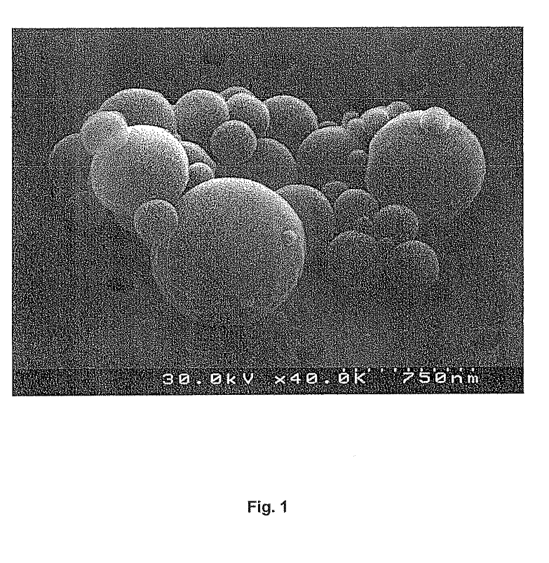

FIG. 1 shows a scanning electron microscope image of crosslinked PMMA polymer particles which have been produced by the process according to the invention.

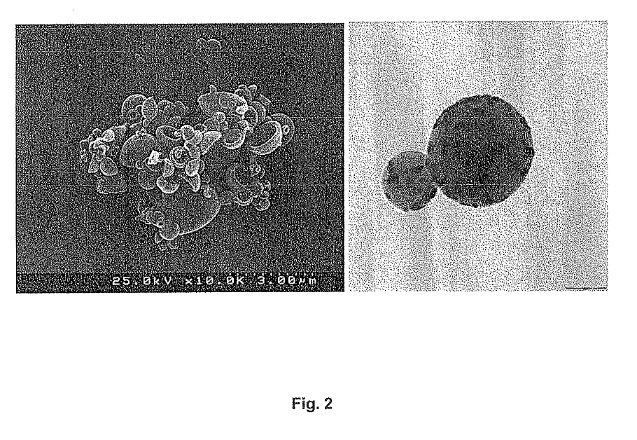

FIG. 2 shows images of nanostructured polymer particles. Depicted on the left are nanodishes (scanning electron microscope image), and on the right are depicted hybrid nanoparticles consisting of ZnO nanoparticles and a polymer (transmission electron microscope image).

FIG. 3 shows a schematic diagram of a dish-shaped particle. dₐ is the outer diameter and dᵢ the inner diameter. dᵢ is calculated from the diameter of the largest sphere which fits in the indentation, without this sphere projecting beyond the indentation.

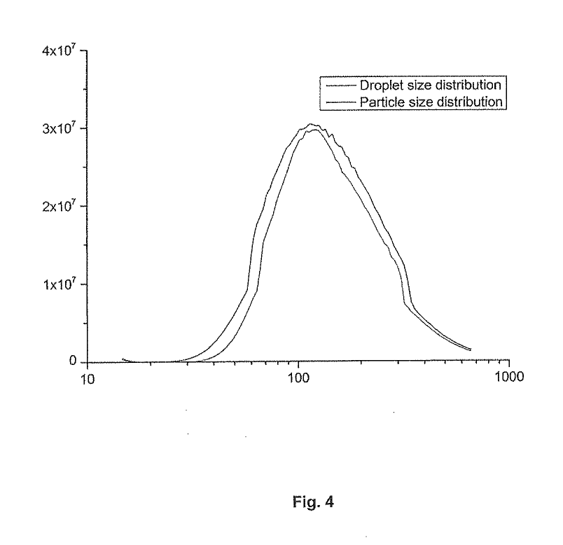

FIG. 4 shows a particle size distribution characteristic of the invention. The x axis shows the diameter of the particles in nm; the y axis describes the number of particles per cm³.

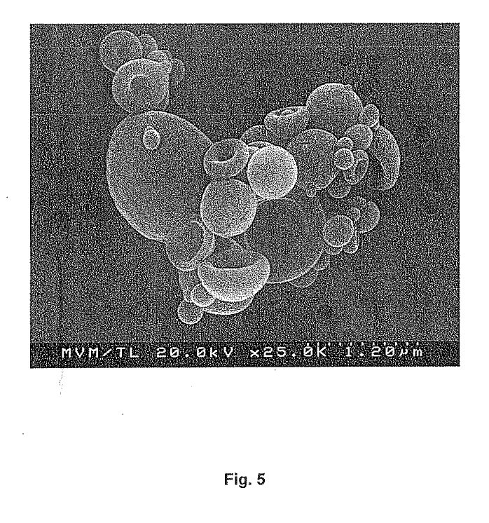

FIG. 5 shows a scanning electron microscope image of nanodishes having benzyl methacrylate as the monomer according to example 23.

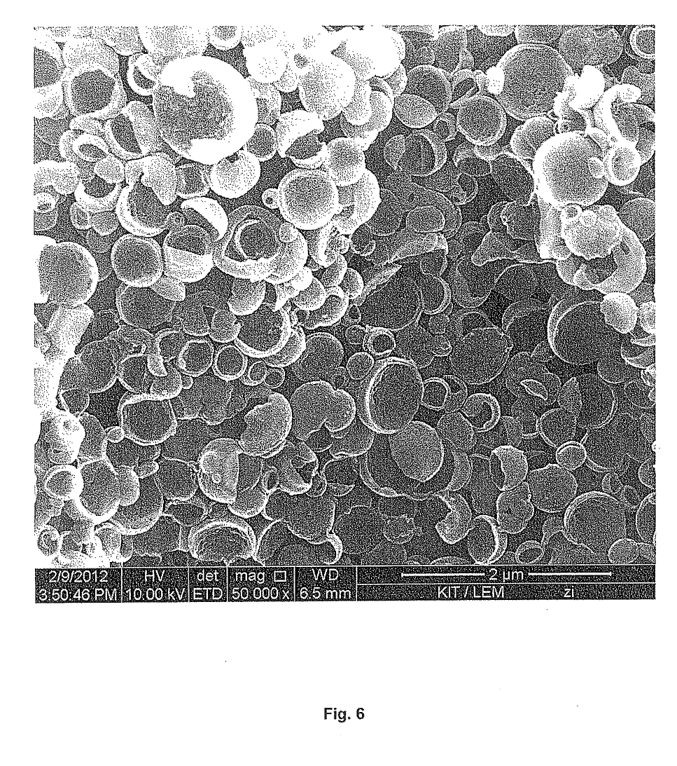

FIG. 6 shows a scanning electron microscope image of hybrid nanodishes having methyl methacrylate as the monomer and ZnO as nanoparticle according to example 24.

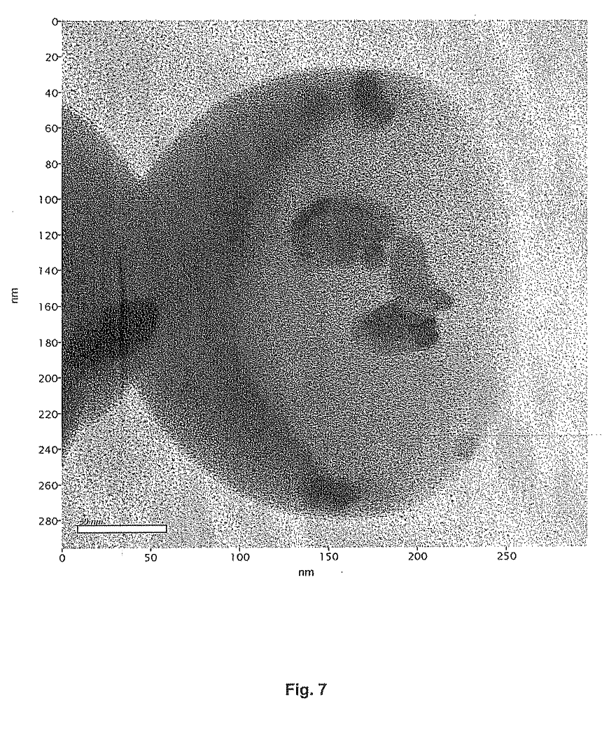

FIG. 7 shows a transmission electron microscope image of hybrid nanodishes having methyl methacrylate as the monomer and ZnO as nanoparticle according to example 24.

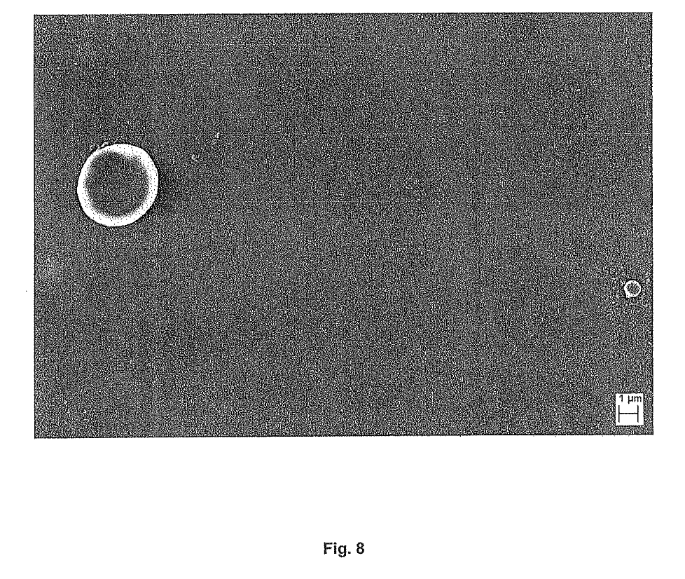

FIG. 8 shows a scanning electron microscope image of copolymer-particles made of butylacrylate (BA) and methyl methacrylate (MMA) as the monomers according to example 29.

### EXAMPLES

The laboratory systems constructed consist essentially of a commercially available atomizer and a self-constructed photoreactor. In order to form nanoscale ball-shaped (co)polymer particles, a solution is first prepared. This solution includes one or more monomers, the photoinitiator and optionally a crosslinker. The prepared solution is introduced into the reservoir vessel of the atomizer (atomizer with two-substance nozzle) and atomized with the aid of nitrogen (N₂). The nitrogen-borne droplet aerosol of nanoscale monomer droplets is passed through the flow photoreactor, where the photoinitiated polymerization of the monomer droplets to give nanoscale polymer particles or copolymer particles takes place. The gas-borne particles are then either deposited on a filter or converted to the liquid phase. The following radiators are used:
excimer XeCl radiator (10 mW/cm² on the radiator surface)
UV fluorescence tube (8 mW/cm² on the radiator surface)

Further structures by means of aerosol photopolymerization: before the atomization, the starting solution can be admixed with a solvent and/or cosolvent in order to form nanodishes (nanodishes) in the photoreactor (FIG. 2, on the left). Hybrid nanoparticles can be produced when inorganic particles are suspended in the starting solution and atomized with the solution (FIG. 2, on the right).

The examples which follow specify the composition of the solutions used.

### Example 1

For the production of the particles shown in FIG. 1, a solution comprising methyl methacrylate (MMA) as a monomer is used. The crosslinker used is 1,6-hexanediol diacrylate (HDDA, 5% by volume in relation to MMA), and the photoinitiator used is 2-methyl-1-[4-(methylthio)phenyl]-2-morpholinopropan-1-one (Irgacure 907, 1% by weight in relation to MMA).

### Example 2

For the production of the nanodishes depicted in FIG. 2 on the left, a solution of methyl methacrylate (MMA) as a monomer and ethanol (45.45% by volume in MMA) as the solvent is prepared. Dissolved therein are 1,6-hexanediol diacrylate (HDDA, 10% by volume in relation to MMA) as a crosslinker 2-methyl-1-[4-(methylthio)phenyl]-2-morpholinopropan-1-one (Irgacure 907, 5% by weight in MMA) as a photoinitiator, and glycerol (26.18% by weight in MMA). Nanoparticles are obtained in the size range from 100 to 400 nm (more than 75% of the particles within this range). Dish-shaped particles are generated in a proportion of >95%.

### Example 3

For the production of the nanoscale hybrid particles, a suspension of zinc oxide particles in ethanol (40% by weight of ZnO in ethanol/1.74% by weight in MMA) and methyl methacrylate (MMA) as the monomer is used. The crosslinker used is 1,6-hexanediol diacrylate (HDDA, 10% by volume in relation to MMA), and the photoinitiator used is 2-methyl-1-[4-(methylthio)phenyl]-2-morpholinopropan-1-one (Irgacure 907, 1% by weight in MMA). Hybrid particles are generated in a proportion of >98%.

### Example 4

For the production of the further homopolymers of polymethyl methacrylate, a solution comprising methyl methacrylate (MMA) as the monomer is used. The crosslinker used is 1,6-hexanediol diacrylate (HDDA, 10% by volume in relation to MMA) and the photoinitiator used is 2-methyl-1-[4-(nnethylthio)phenyl]-2-morpholinopropan-1-one (Irgacure 907, 1% by weight in MMA). Nanoparticles are obtained in the size range from 60 to 350 nm (more than 75% of the particles within this range).

### Example 5

For the production of the further homopolymers of polymethyl methacrylate, a solution comprising methyl methacrylate (MMA) as the monomer is used. The crosslinker used is 1,6-hexanediol diacrylate (HDDA, 20% by volume in relation to MMA) and the photoinitiator used is 2-methyl-1-[4-(methylthio)phenyl]-2-morpholinopropan-1-one (Irgacure 907, 1% by weight in MMA).

### Example 6

For the production of the homopolymers of polybutyl acrylate, a solution comprising butyl acrylate (BA) as the monomer is used. The crosslinker used is 1,6-hexanediol diacrylate (HDDA, 10% by volume in relation to MMA) and the photoinitiator used is 2-methyl-1-[4-(methylthio)phenyl]-2-morpholinopropan-1-one (Irgacure 907, 1% by weight in MMA).

### Example 7

For the production of the homopolymers of polybutyl acrylate, a solution comprising butyl acrylate (BA) as the monomer is used. No crosslinker is used and the photoinitiator used is 2-methyl-1-[4-(methylthio)phenyl]-2-morpholinopropan-1 -one (Irgacure 907, 1% by weight in MMA). Nanoparticles are obtained in the size range from 60 to 350 nm (more than 75% of the particles within this range).

### Example 8

For the production of the homopolymers of polybenzyl methacrylate, a solution comprising benzyl methacrylate (BzMA) as the monomer is used. The crosslinker used is 1,6-hexanediol diacrylate (HDDA, 10% by volume in relation to MMA) and the photoinitiator used is 2-methyl-1-[4-(methylthio)phenyl]-2-morpholinopropan-1-one (Irgacure 907, 1% by weight in MMA). Nanoparticles are obtained in the size range from 60 to 300 nm (more than 75% of the particles within this range).

### Example 9

For the production of the nanoscale hybrid particles, a suspension of zinc oxide particles in ethanol (40% by weight of ZnO in ethanol/21.01% by weight in MMA) and methyl methacrylate (MMA) as the monomer is used. The crosslinker used is 1,6-hexanediol diacrylate (HDDA, 10% by volume in relation to MMA), and the photoinitiator used is 2-methyl-1-[4-(methylthio)phenyl]-2-morpholinopropan-1-one (Irgacure 907, 1% by weight in MMA).

### Example 10

For the production of the nanoscale hybrid particles, a suspension of zinc oxide particles in ethanol (40% by weight of ZnO in ethanol/0.64% by weight in BzMA) and benzyl methacrylate (BzMA) as the monomer is used. The crosslinker used is 1,6-hexanediol diacrylate (HDDA, 10% by volume in relation to BzMA), and the photoinitiator used is 2-methyl-1-[4-(methylthio)phenyl]-2-morpholinopropan-1-one (Irgacure 907, 1% by weight in BzMA). Hybrid particles are generated in a proportion of >98%.

### Example 11

For the production of the nanoscale hybrid particles, a suspension of zinc oxide particles in ethanol (40% by weight of ZnO in ethanol/0.74% by weight in BA) and butyl acrylate (BA) as the monomer is used. The crosslinker used is 1,6-hexanediol diacrylate (HDDA, 10% by volume in relation to BA), and the photoinitiator used is 2-methyl-1-[4-(methylthio)phenyl]-2-morpholinopropan-1-one (Irgacure 907, 1% by weight in BA).

### Example 12

For the production of the nanoscale hybrid particles, a suspension of zinc oxide particles in ethanol (40% by weight of ZnO in ethanol/0.74% by weight in BA) and butyl acrylate (BA) as the monomer is used. No crosslinker is used, and the photoinitiator used is 2-methyl-1-[4-(methylthio)phenyl]-2-morpholinopropan-1-one (Irgacure 907, 1% by weight in BA). Nanoparticles are obtained in the size range from 70 to 400 nm (more than 75% of the particles within this range). Hybrid particles are generated in a proportion of >95%.

### Example 13

For the production of the nanoscale hybrid particles, a suspension of zinc oxide particles in ethanol (40% by weight of ZnO in ethanol/0.74% by weight in BA) and butyl acrylate (BA) as the monomer is used. The crosslinker used is 1,6-hexanediol diacrylate (HDDA, 10% by volume in BA). The zinc oxide particles act as photoinitiator. Hybrid particles are generated in a proportion of >95%.

### Example 14

For the production of the nanoscale hybrid particles, a suspension of zinc oxide particles in ethanol (40% by weight of ZnO in ethanol/0.74% by weight in BA) and butyl acrylate (BA) as the monomer is used. No crosslinker is used. The zinc oxide particles act as photoinitiator. Hybrid particles are generated in a proportion of >98%.

### Example 15

For the production of the further homopolymers of polymethyl methacrylate, a solution comprising methyl methacrylate (MMA) as the monomer is used. No crosslinker is used and the photoinitiator used is 2-methyl-1-[4-(methylthio)phenyl]-2-morpholinopropan-1-one (Irgacure 907, 1% by weight in MMA). This does not generate any particles.

### Example 16

For the production of the nanodishes a solution of methyl methacrylate (MMA) as the monomer and 1-propanol (45.45% by volume in MMA) as the solvent is prepared. Dissolved therein are 1,6-hexanediol diacrylate (HDDA, 10% by volume in relation to MMA) as a crosslinker, 2-methyl-1-[4-(methylthio)phenyl]-2-morpholinopropan-1-one (Irgacure 907, 5% by weight in MMA) as a photoinitiator, and glycerol (26.18% by weight in MMA). The proportion of the particles in dish shape is greater than 98%.

### Example 17

For the production of the nanodishes, a solution of methyl methacrylate (MMA) as the monomer and ethanol (45.45% by volume in MMA) as the solvent is prepared. Dissolved therein are 1,6-hexanediol diacrylate (HDDA, 20% by volume in relation to MMA) as a crosslinker, 2-methyl-1-[4-(methylthio)phenyl]-2-morpholinopropan-1-one (Irgacure 907, 5% by weight in MMA) as a photoinitiator, and glycerol (26.18% by weight in MMA). The proportion of the particles in dish shape is greater than 98%.

### Example 18

For the production of the nanodishes a solution of methyl methacrylate (MMA) as the monomer and 1-propanol (45.45% by volume in MMA) as the solvent is prepared. Dissolved therein are 1,6-hexanediol diacrylate (HDDA, 20% by volume in relation to MMA) as a crosslinker, 2-methyl-1-[4-(methylthio)phenyl]-2-morpholinopropan-1-one (Irgacure 907, 5% by weight in MMA) as a photoinitiator, and glycerol (26.18% by weight in MMA).

### Example 19

For the production of the homopolymers of polystyrene, a solution comprising styrene as the monomer is used. The crosslinker used is 1,6-hexanediol diacrylate (HDDA, 10% by volume in relation to styrene), and the photoinitiator used is 2-methyl-1-[4-(methylthio)phenyl]-2-morpholinopropan-1-one (Irgacure 907, 5% by weight in styrene).

### Example 20

For the production of the copolymers of styrene and methyl methacrylate, a solution comprising styrene and methyl methacrylate (MMA) as the monomer is used. The volume ratio of MMA to styrene is 3. The crosslinker used is 1,6-hexanediol diacrylate (HDDA, 10% by volume in relation to MMA+styrene), and the photoinitiator used is 2-methyl-1-[4-(methylthio)phenyl]-2-morpholinopropan-1-one (Irgacure 907, 5% by weight in MMA+styrene).

### Example 21

### Nanodishes Having Butylacrylate as the Monomer

For the production of nanodishes, a solution comprising butylacrylate (BA) as the monomer and ethanol (45.45% by volume in BA) as solvent is used. The crosslinker used is 1,6-hexanediol diacrylate (HDDA, 10% by volume in relation to BA), 2-methyl-1[4-(methylthio)phenyl]-2-morpholinopropane-1-one (Irgacure 907, 5% by weight in BA) as photoinitiator and glycerol (27.07% by weight in BA) are dissolved therein.

### Example 21b

### Nanodishes Having Butylacrylate as the Monomer

For the production of nanodishes, a solution comprising butylacrylate (BA) as the monomer and ethanol (45.45% by volume in BA) as solvent is used. No crosslinker is used and 2-methyl-1[4-(methylthio)phenyl]-2-morpholinopropane-1-one (Irgacure 907, 5% by weight in BA) as photoinitiator and glycerol (27.07% by weight in BA) are used.

### Example 22

### Hybrid Particles Having MMA as the Monomer and without Irgacure 907

For the production of nanoscale hybrid particles, a suspension of zinc oxide particles in ethanol (40% by weight ZnO in ethanol/6.62% by weight in MMA) and methyl methacrylate (MMA) as the monomer are used. The crosslinker used is 1,6-hexanediol diacrylate (HDDA, 10% by volume in relation to MMA). The zinc oxide particles act as the photoinitiator.

### Example 23

### Nanodishes Having Benzylmethacrylate as the Monomer

For the production of nanodishes, a solution of benzylmethacrylate (BzMA) as the monomer and ethanol (45.45% by weight in BzMA) as the solvent is prepared. 1,6-hexanediol diacrylate (HDDA, 20% by volume in relation to BzMA) as crosslinker, 2-methyl-1[4-(methylthio)phenyl]-2-morpholinopropane-1-one (Irgacure 907, 5% by weight in BzMA) as the photoinitiator and glycerol (24.27% by weight in BzMA) are dissolved therein.

### Example 24

### Hybrid Nanodishes Having Methyl Methacrylate as the Monomer

For the production of hybrid nanodishes methyl methacrylate (MMA) is used as the monomer. A crosslinker used is 1,6-hexanediol diacrylate (HDDA, 10% by weight in relation to MMA) and as photoinitiator 2-methyl-1[4-(methylthio)phenyl]-2-morpholinopropane-1-one (Irgacure 907, 5% by weight in MMA) are dissolved in the monomer. This solution is dissolved in ethanol (45.45% by weight ethanol in MMA). Glycerol is also dissolved in this solution (26.18% by weight in MMA). The solution that is obtained is mixed with a suspension of zinc oxide particles in ethanol (40% by weight ZnO in ethanol/0.50% by weight in MMA) to obtain a monomer suspension.

### Example 25

### Hybrid Nanodishes Having Methyl Methacrylate as the Monomer

For the production of hybrid nanodishes methyl methacrylate (MMA) is used as the monomer. A crosslinker used is 1,6-hexanediol diacrylate (HDDA, 10% by weight in relation to MMA) and as photoinitiator 2-methyl-1[4-(methylthio)phenyl]-2-morpholinopropane-1-one (Irgacure 907, 5% by weight in MMA) are dissolved in the monomer. This solution is dissolved in ethanol (45.45% by weight ethanol in MMA). Glycerol is also dissolved in this solution (26.18% by weight in MMA). The solution that is obtained is mixed with a suspension of zinc oxide particles in ethanol (40% by weight ZnO in ethanol/1.50% by weight in MMA) to obtain a monomer suspension.

### Example 26

### Hybrid Nanodishes Having Methyl Methacrylate as the Monomer

For the production of hybrid nanodishes methyl methacrylate (MMA) is used as the monomer. A crosslinker used is 1,6-hexanediol diacrylate (HDDA, 10% by weight in relation to MMA) and as photoinitiator 2-methyl-1[4-(methylthio)phenyl]-2-morpholinopropane-1-one (Irgacure 907, 5% by weight in MMA) are dissolved in the monomer. This solution is dissolved in ethanol (45.45% by weight ethanol in MMA). Glycerol is also dissolved in this solution (26.18% by weight in MMA). The solution that is obtained is mixed with a suspension of zinc oxide particles in ethanol (40% by weight ZnO in ethanol/3.00% by weight in MMA) to obtain a monomer suspension.

### Example 27

### Copolymer

For the production of copolymers of butylacrylate (BA) and methyl methacrylate (MMA) a solution of butylacrylate and methyl methacrylate (MMA) as monomer is used. The ratio of volume of MMA to BA is 1/1. No crosslinker is used and 2-methyl-1[4-(methylthio)phenyl]-2-morpholinopropane-1-one (Irgacure 907, 1% by weight in MMA+BA) is used as the photoinitiator.

### Example 28

### Copolymer

For the production of copolymers of butylacrylate (BA) and methyl methacrylate (MMA) a solution of butylacrylate and methyl methacrylate (MMA) as monomer is used. The ratio of volume of MMA to BA is 9/1. No crosslinker is used and 2-methyl-1[4-(methylthio)phenyl]-2-morpholinopropane-1-one (Irgacure 907, 1% by weight in MMA+BA) is used as the photoinitiator.

### Example 29

### Copolymer

For the production of copolymers of butylacrylate (BA) and methyl methacrylate (MMA) a solution of butylacrylate and methyl methacrylate (MMA) as monomer is used. The ratio of volume of MMA to BA is 1/9. No crosslinker is used and 2-methyl-1[4-(methylthio)phenyl]-2-morpholinopropane-1-one (Irgacure 907, 1% by weight in MMA+BA) is used as the photoinitiator.

### Example 30

### Copolymer

For the production of copolymers of butylacrylate (BA) and methyl methacrylate (MMA) a solution of butylacrylate and methyl methacrylate (MMA) as monomer is used. The ratio of volume of MMA to BA is 7/3. No crosslinker is used and 2-methyl-1[4-(methylthio)phenyl]-2-morpholinopropane-1-one (Irgacure 907, 1% by weight in MMA+BA) is used as the photoinitiator.

### Example 31

### Copolymer

For the production of copolymers of butylacrylate (BA) and methyl methacrylate (MMA) a solution of butylacrylate and methyl methacrylate (MMA) as monomer is used. The ratio of volume of MMA to BA is 3/7. No crosslinker is used and 2-methyl-1[4-(methylthio)phenyl]-2-morpholinopropane-1-one (Irgacure 907, 1% by weight in MMA+BA) is used as the photoinitiator.

1-15. (canceled)

16. A process for producing nanoparticles comprising at least one polymer and/or copolymer by providing an aerosol comprising droplets of at least one monomer and at least one photoinitiator in a gas stream, irradiating this aerosol stream with light such that the monomers present polymerize, and removing the nanoparticles formed from the gas stream.

17. The process according to claim 16, wherein the gas stream is an inert gas stream and the polymer is formed by free-radical polymerization.

18. The process according to claim 16, wherein the gas stream is an air or inert gas stream and the polymer is formed by cationic polymerization.

19. The process according to claim 16, wherein the chain growth rate coefficient Kₚ of the polymerization reaction is greater than 500 mol/l/s.

20. The process according to claim 16, wherein the chain growth rate coefficient Kₚ of the polymerization reaction is greater than 2000 mol/l/s.

21. The process according to claim 18, wherein the chain growth rate coefficient Kₚ of the polymerization reaction is greater than 10 000 mol/l/s.

22. The process according to claim 16, wherein the Damköhler number Da of the polymerization reaction is greater than 200 000.

23. The process according to claim 16, wherein the Damköhler number Da of the polymerization reaction is greater than 1 000 000.

24. The process according to claim 16, wherein the droplets additionally comprise at least one solvent.

25. The process according to claim 16, wherein the droplets additionally comprise at least one cosolvent selected from the group consisting of glycerol, glycol, polyethylene glycol, EO/PO copolymers, silicone oils and mixtures thereof.

26. The process according to claim 16, wherein the droplets additionally comprise at least one additive.

27. The process according to claim 16, wherein the nanoparticles are ball-shaped or dish-shaped, or are hollow balls or gel-like balls.

28. The process according to claim 16, wherein the at least one monomer is selected from the group consisting of olefinically unsaturated monomers, epoxides, cyclic ethers, acetals and mixtures thereof.

29. The process according to claim 16, wherein the at least one monomer is selected from the group consisting of olefinically α,β-unsaturated monomers, epoxides, cyclic ethers, acetals and mixtures thereof.

30. The process according to claim 16, wherein the droplets additionally comprise at least one crosslinker.

31. The process according to claim 16, wherein the nanoparticles formed are removed by separation on a filter or on a surface, or by introduction into a liquid medium.

32. Nanoparticles producible by the process according to claim 16.

33. A method of using the nanoparticles according to claim 32 in optical, electronic, chemical or biotechnological systems, or for active ingredient administration which comprises utilizing the nanoparticles according to claim 32.

34. The method according to claim 33, wherein the nanoparticles are used as photosensitizers and/or photoinitiators.
